(19) United States
(12) Patent Application Publication
(10) Pub. No.: US 2026/0175632 A1
(43) Pub. Date: Jun. 25, 2026

(54) Tire Deflator

(71) Applicant: Wheel Pros, LLC, Greenwood Village, CO (US)

(72) Inventors: Stephen Blake Farley, Salt Lake City, UT (US); Casey Heit, Salt Lake City, UT (US); Spencer K. Klakring, Salt Lake Ciity, UT (US)

(73) Assignee: Wheel Pros, LLC, Greenwood Village, CO (US)

(21) Appl. No.: 19/428,446

(22) Filed: Dec. 22, 2025

Related U.S. Application Data
(60) Provisional application No. 63/738,751, filed on Dec. 24, 2024.

(51) Int. Cl. B60C 29/00; B60C 29/06; F16K 15/20

(52) U.S. Cl. CPC B60C 29/005; B60C 29/068; F16K 15/20

(57) ABSTRACT

A tire deflator includes a base, a cover, a poppet, and a biasing member. The base defines an air channel and a deflation port in selective fluid communication with the air channel. A body of the poppet configured to translate between an open pose in which the poppet is positioned to allow air to flow from the air channel through the deflation port and a closed pose in which the poppet is positioned to occlude the deflation port. The biasing member positioned within the base and exerts a closing force on the poppet to urge the poppet towards the closed pose. The poppet configured to release air from the air channel until air pressure within the air channel is at a set air pressure when the air pressure within the air channel is above the set air pressure.

### CROSS-REFERENCE TO RELATED APPLICATION

This application claims benefit of, and priority to, U.S. Provisional Patent Application Ser. No. 63,738,751, filed Dec. 24, 2024, the entire contents of which are hereby incorporated by reference.

### BACKGROUND

### 1. Technical Field

The present disclosure relates generally to the field of inflation and deflation of vehicle tires, and more specifically, to a universal tire deflator.

### 2. Discussion of Related Art

Most vehicles are driven on paved roads and have a set amount of air pressure that provides optimum performance for a particular tire. On the other hand, offroad enthusiasts prefer specifically designed offroad tires and will often change the air pressure inside of their tires depending on conditions. For example, a vehicle traveling over rocky terrain with numerous obstacles will lower the air pressure in the tires prior to traversing the terrain, and then “air up” again after traversing the rocky terrain.

While passenger vehicle wheels usually have a single valve used to inflate and deflate the tires, offroad wheels often have two separate or “dual” valves to make the “airing down” and “airing up” easier and faster. There are a variety of products on the market today that attempt to facilitate the inflation and deflation of offroad tires, but do not provide a strong, easy to use replacement for these valve stems that also allow the user to preset a desired pressure.

Currently, there are a number of attempts to solve the problem stated above, including a number of patents, published patent applications, and products on the market that attempt to solve the problem that the current invention directly addresses.

For example, there are tire deflators that include the Monster Valve by Power Tank, the RPV by Apex, and the Staun Tire Deflator. However, none of these devices include all the features as detailed below.

### SUMMARY

This disclosure relates generally to a tire deflator that combines a “pre-set” air pressure feature with a strong valve replacement. The disclosed tire deflator provides a solution by having a tire deflator that allows the user to establish a “set air pressure” through use of an air pressure gauge and the setting of an internal adjustment ring. The disclosed tire deflator may be used for both single valve and dual valve models of wheels. When used with a single valve wheel, a user can rapidly “air down” to a predefined pressure confidently without any additional components. When used with a dual valve wheel, a user can easily attach a gauge to the secondary valve and check pressure as the tire is rapidly deflated using the disclosed tire deflator as a primary port.

The set air pressure feature allows an off-roader to simply “air down” to the desired air pressure, with no need to constantly fiddle with an air pump and air pressure gauge to see how close the tire is to the desired air pressure. The tire deflator has no additional parts, and thereby avoids the problems with the prior art that merely attaches to an existing valve, or tries to replace an existing valve with a delicate combination of parts that is highly subject to breakage under the rigorous road conditions that offroad vehicles encounter on a regular basis. The disclosed tire deflator does not require any special parts in the wheel, but rather, can simply mount to a standard port. For typical use, no tools are required, but to adjust the pressure settings an adjuster tool may be used.

The disclosed tire deflator provides a solution for a long-felt need by providing a tire deflator that can replace an existing valve in a wheel. A spring-loaded poppet combines with a threaded adjustment ring to shut off the release of air once the air pressure inside the tire reaches a pre-set and desired air pressure. By allowing a user to pre-set an amount of air pressure desired for off-roading, the process of “air downing” tires before entering rough terrain is made easy, efficient, and avoids the testing and measuring that is required by the prior art. The disclosed tire deflator is a single-item replacement for a valve and does not require any additional parts to function. By allowing a user to preset the air pressure, the disclosed tire deflator allows an off-roader to quickly “air down” the tires to a desired pressure, rather than bleeding out air, then measure with an air pressure gauge, then either bleeding out more air, or in the case where the user overly deflated the tires, pumping the tire back up. To adjust the set pressure, a threaded adjustment ring is screwed up or down to set a desired pressure, and once the pressure of the tire equals the desired pressure, a spring-loaded poppet will self-seal, thereby preventing escape of more air.

In an aspect of the present disclosure, tire deflator includes a base, a cover, a poppet, and a biasing member. The base is configured to secure even a valve port of a wheel. The base defines an air channel that is configured to be in fluid communication with the tire cavity. The base defines a deflation port in selective fluid communication with the air channel. The cover has a secured position in which the cover occludes the deflation port and an unsecured position in which the cover is positioned outward of the deflation port. The poppet has a body that is configured to translate inward and outward within the base between an open pose in which the poppet is positioned to allow air to flow from the air channel through the deflation and a closed pose in which the poppet is positioned to occlude the deflation port. The poppet is free to translate between the open pose and the closed pose when the cover is in the unsecured position. The biasing member is positioned within the base and exerts a closing force on the poppet to urge the poppet towards the closed pose. The poppet is configured to release air from the air channel until air pressure within the air channel is at a set air pressure and the cover is in the unsecured position and the air pressure within the air channel is above the set air pressure.

In aspects, the tire deflator further includes a set ring that is disposed within the base and about the body of the poppet. The biasing member may be disposed between the set ring and a stop on the inward end portion of the poppet. The set ring may be translatable within the base along the body of the poppet such that a closing force of the biasing member on the poppet is adjusted between a maximum closing force associated with a maximum set air pressure and a minimum closing force associated with a minimum set air pressure. The maximum set air pressure may be in a range of 24 psi to 36 psi and the minimum set air pressure may be in a range of 4 psi to 12 psi.

In some aspects, the set ring is translatable relative to the base to adjust the set air pressure. The set ring may be rotated relative to the base to translate that ring relative to the base.

In certain aspects, the tire deflator includes a tire pressure monitoring system mount that is configured to be disposed within a tire cavity defined between a wheel and a tire. The base is configured to pass through and mount within a standard valve port in a wheel. In the secured position of the cover, the cover is threadedly coupled with the base and the cover retains the poppet in the closed pose thereof.

In particular aspects, the tire deflator includes a snap ring in an outward end portion of the base and retains the set ring within the base.

In another aspect of the present disclosure, a wheel system includes a wheel and a tire deflator as detailed herein. The wheel defines a valve port that is in fluid communication with the tire cavity that is defined between the wheel and tire mounted to a wheel. The system may include a tire mounted to the wheel to define the tire cavity between the wheel and the tire.

In another aspect of the present disclosure, a tire deflator includes a base, a poppet, and a biasing member. The base is configured to install in a valve port of a wheel and defines an air channel that is configured to be in fluid communication with the tire cavity. The base also defines a deflation port in selective fluid communication with the air channel. The poppet has a body in which the poppet is positioned to allow air to flow from the air channel out of the deflation port and a closed pose in which the poppet is positioned to occlude the deflation port to retain air within the air channel. The biasing member is positioned within the base and exerts a closing force on the poppet to urge the poppet towards the closed pose. The poppet is configured to be urged towards the open pose by air pressure within the air channel. The poppet is configured to self-seal the deflation port when the closing force is greater than the force exerted on the poppet by the air pressure within the air channel such that a set air pressure is retained in the air channel.

In aspects, the tire deflator further includes a set ring that is disposed within the base and about the body of the poppet. The biasing member is disposed between the set ring and a stop of the poppet disposed in an inward end portion of the poppet. The set ring may be translatable relative to the base to adjust the closing force of the biasing member and the set air pressure.

In another aspect of the present disclosure, a method of “airing down” a tire includes releasing the poppet of a tire deflator that is installed in a valve port of a wheel such that the air pressure within a tire cavity defined between the wheel and tire and to urge the poppet outward towards an open pose of the poppet to expose the deflation port of the base of the tire deflator. The base is secured within the valve port of the wheel. The method further includes waiting for the poppet to self-seal the deflation port when the pressure within the tire cavity is at a set air pressure.

In aspects, releasing the poppet includes rotating the cover secured to the base to release the cover and the poppet. The cover may occlude the deflation port and retain the poppet in a closed pose when secured to the base. Waiting for the poppet to self-seal the deflation port may include a biasing member exerting a closing force on the poppet to urge the poppet towards a closed pose in which the poppet seals the deflation port.

In some aspects, the method includes adjusting the closing force of the biasing member by rotating a set ring that is threadably coupled to the base about a body of the poppet to adjust the set air pressure.

In certain aspects, the method includes rotating a cover to secure the cover to the base and to occlude the deflation portion. The method may include adding air into an outward end of the poppet through a valve installed within the poppet such that the pressure within the tire cavity is greater than the set air pressure.

Further, to the extent consistent, any of the embodiments or aspects described herein may be used in conjunction with any or all of the other embodiments or aspects described herein.

### BRIEF DESCRIPTION OF THE DRAWINGS

Various aspects of the present disclosure are described hereinbelow with reference to the drawings, which are not necessarily drawn to scale, which are incorporated in and constitute a part of this specification, wherein:

FIG. 1 illustrates a traditional offroad wheel and tire;

FIG. 2 is a side view of a tire deflator provided in accordance with the present disclosure with a portion of the wheel of FIG. 1 cutaway.

FIG. 3 is a side, longitudinal cross-sectional view of the tire deflator of FIG. 2;

FIG. 4 is a side, longitudinal cross-sectional view of the tire deflator of FIG. 2 in a closed configuration;

FIG. 5 is a side, longitudinal cross-sectional view of the tire deflator of FIG. 2 in a maximum pressure configuration and in an open pose;

FIG. 6 is a side, longitudinal cross-sectional view of the tire deflator of FIG. 2 in the maximum pressure configuration an in a closed pose;

FIG. 7 is a side, longitudinal cross-sectional view of the tire deflator of FIG. 2 in a minimum pressure configuration and in an open pose;

FIG. 8 is a side, longitudinal cross-sectional view of the tire deflator of FIG. 2 in an adjustment configuration; and

FIG. 9 is a side, longitudinal cross-sectional view of the tire deflator of FIG. 2 in an air up configuration.

### DETAILED DESCRIPTION

The present disclosure will now be described more fully hereinafter with reference to example embodiments thereof with reference to the drawings in which like reference numerals designate identical or corresponding elements in each of the several views. These example embodiments are described so that this disclosure will be thorough and complete, and will fully convey the scope of the disclosure to those skilled in the art. Features from one embodiment or aspect can be combined with features from any other embodiment or aspect in any appropriate combination. For example, any individual or collective features of method aspects or embodiments can be applied to apparatus, product, or component aspects or embodiments and vice versa. The disclosure may be embodied in many different forms and should not be construed as limited to the embodiments set forth herein; rather, these embodiments are provided so that this disclosure will satisfy applicable legal requirements. As used in the specification and the appended claims, the singular forms “a,” “an,” “the,” and the like include plural referents unless the context clearly dictates otherwise. In addition, while reference may be made herein to quantitative measures, values, geometric relationships or the like, unless otherwise stated, any one or more if not all of these may be absolute or approximate to account for acceptable variations that may occur, such as those due to manufacturing or engineering tolerances or the like.

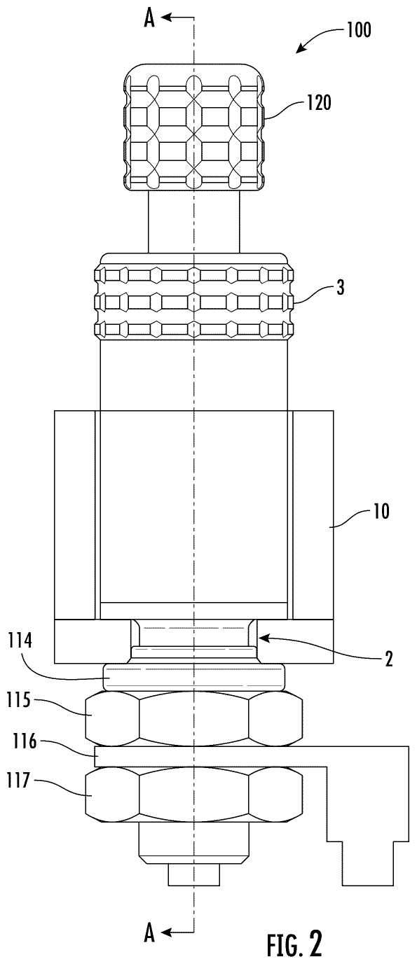

As used herein, the direction “inward” is towards a tire cavity defined between a tire and a wheel that is configured to retain air at a pressure greater than atmospheric pressure and the direction “outward” is away from the tire cavity and is opposite the “inward” direction. Further, with respect to FIGS. 2-9, the inward direction is down and the outward direction is up along a central longitudinal axis of the tire deflator shown in the respective figure.

As used herein, the phrase “configured to” describes a related element that must be made, suited by nature, character, or designed for a particular use, purpose, or situation. In contrast, the phrase “capable of” describes a related element that only needs to be suitable for a particular use, purpose, or situation.

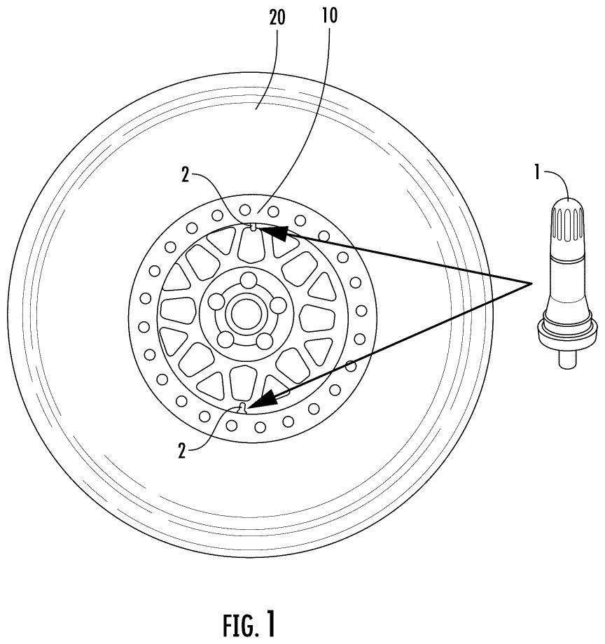

Referring now to FIG. 1, a traditional offroad wheel 10 and tire 20 are provided to show the location of valves 1. Offroad wheels may include two valve ports 2 that allow for two valves 1 to be installed to aid in setting the air pressure within the tire 20. Specifically, a first valve 1 may be used to let air in or out of the tire and a second valve 1 may be used to measure the pressure with an air gauge. Setting air pressure in an offroad tire may be more frequent than vehicles that are used on traditional paved roads. For example, a user may lower air pressure in a tire when about drive over rough terrain. While the two valves allow for a user to measure pressure within the tire at the same time as filling, the disclosed tire deflator may be used with two valve wheels or single valve wheels.

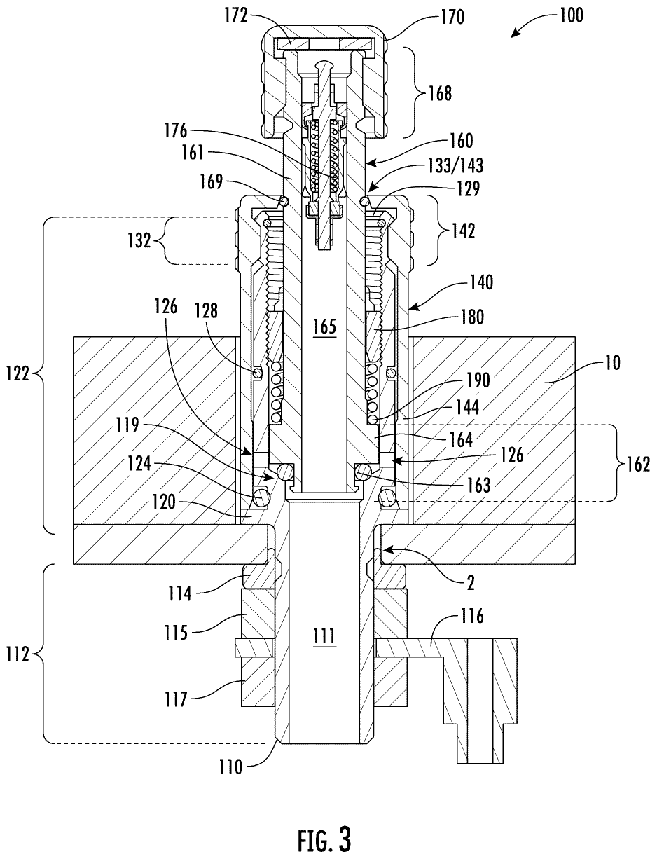

With reference to FIGS. 2 and 3, a tire deflator 100 is provided in accordance with the present disclosure. The tire deflator 100 is installed in a valve port 2 of a wheel 10. The tire deflator 100 may be installed in a single valved wheel or a multi-valved wheel, e.g., a two-valved wheel such as wheel 10. The tire deflator 100 allows for a desired set pressure to be set allowing for quick deflation of a tire to the desired set pressure without a need to check the pressure. The tire deflator 100 includes a base 110, a cover 140, a poppet 160, a cap 170, a set ring 180, and a biasing member 190 as described below. Once the set ring 180 is set, as detailed below, the tire deflator 100 is used to release excess pressure from a tire cavity. The tire deflator 100 may be used to set the desired pressure without any additional parts. Specifically, the cap 170 is unsecured and the poppet 160 releases excess pressure until the desired pressure is reached. When the desired pressure is reached, the poppet 160 self-seals to retain the desired pressure within the tire cavity. Once the desired pressure is reached, the cap 170 may be resecured.

The base 110 includes a mounting portion 112 and an adjustment portion 122. The mounting portion 112 extends through the valve port 2 of the wheel 10 and defines an air channel 111 that allows for inflow and outflow of air into and out of a tire mounted to the wheel 10. The base 110 may include a mounting portion 112 that extends into the inside of the wheel 10. The mounting portion 112 may be threaded, e.g., externally threaded. To mount and seal the base 110 within the wheel 10, a valve seal 114 may be disposed about the mounting portion 112 of the base 110 against the wheel and a first retaining nut 115 may be tightened to retain the base 110 within the wheel 10. In some embodiments, the base 110 may provide a mount for a tire pressure monitoring system (TPMS) within the wheel 10. In such embodiments, a TPMS mount 116 may be disposed over the mounting portion 112 and be retained on the mounting portion 112 with another retaining nut 117. The mounting portion 112 of the base 110 may be configured to pass through and secure to a standard valve port in a wheel, e.g., valve port 2 of wheel 10.

The base 110 further includes a retaining flange 120 that abuts the wheel 10 about the valve port 2 and prevents the rest of the base 110 from passing through the valve port 2. In some embodiments, the valve seal 114 may be disposed between the retaining flange 120 and the wheel 10. In certain embodiments, a valve seal 114 may be disposed on both sides of the wheel 10. The mounting portion 112 extends inward from the retaining flange 120 and the adjustment portion 122 extends outward form the retaining flange 120. The base 110 includes a lower seal 124 that is disposed about the base 110 and against the retaining flange 120. The lower seal 124 may be an O-ring that is disposed within a groove defined by the base 110. The adjustment portion 122 terminates in an outer threaded portion 132 that is disposed at an end of the base 110 that is positioned away from the mounting portion 112. The outer threaded portion 132 may define a poppet opening 133 that allows the poppet 160 to be retained and to pass therethrough. The base 110 also defines deflation ports 126 adjacent the retaining flange 120. The deflation ports 126 are in fluid communication with the air channel 111 and are configured to allow air to exit the interior of a tire as detailed below. The deflation ports 126 are positioned outward of the lower seal 124. The base 110 may also include an adjuster seal 128 that is disposed about the adjustment portion 122 outward of the deflation ports 126. The interior of the adjustment portion 122 is threaded to cooperate with the set ring 180 as detailed below.

The cover 140 is disposed about the adjustment portion 122 of the base 110. The outward portion end of the cover 140 includes a threaded section 142 that is configured to cooperate with the threaded portion 132 of the base 110 to selectively secure the cover 140 to the adjustment portion 122. The cover 140 includes a shell 144 that extends from the threaded section 142 about the base 110 to the retaining flange 120 when the cover 140 is threadedly secured to the threaded portion 132 of the base 110. When the cover 140 is secured to a base 110, the shell 144 covers and forms a seal with the deflation ports 126. The lower seal 124 may form a seal with the shell 144 to prevent air from exiting through the deflation ports 126. The outward end of the cover 140 defines a poppet opening 143 that allows the poppet 160 to pass through the cover 140.

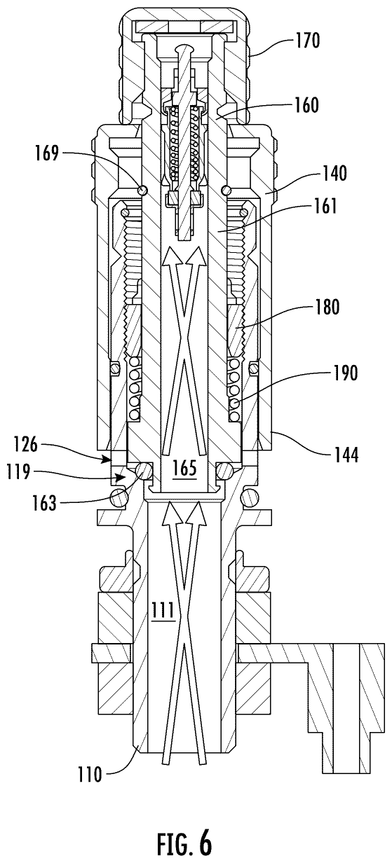

The poppet 160 has a body 161 that includes an inward end segment 162 and an outward end segment 168. The inward end segment 162 includes a stop 164. The stop 164 is spaced apart from the inward end of the poppet 160 such that a poppet seal 163 may be disposed about the body 161 on an inward side of the stop 164 that is configured to form a seal with the base 110 when the poppet 160 is in the closed pose as detailed below (FIG. 6). The base 110 may define a poppet seat 119 inward from the deflation ports 126 that is configured to receive the poppet seal 163 such that the poppet 160 closes the deflation ports 126. The outward side of the stop 164 is engaged by the biasing member 190 such that the stop 164 is urged inward by the biasing member 190 as detailed below. When the poppet seal 163 is outward of the deflation ports 126, the poppet seal 163 and the stop 164 may form a seal with the interior of the base 110 to retain air within the tire. The base 110 may include a snap ring 129 that is disposed in the threaded portion 132 that retains the set ring 180 within the base 110.

The body 161 of the poppet 160 defines a poppet air channel 165 that is in fluid communication with the air channel 111 of the base 110. The outward end segment 168 of the poppet 160 is threaded on an outer surface and is configured to receive the cap 170. The cap 170 may include a cap seal 172 that seals the outward end of the poppet 160 when the cap 170 is secured to the poppet 160. The body 161 is configured to receive a standard Schrader valve 176 in the poppet air channel 165 to selectively seal the outward end of the poppet 160. The cover 140 is removable from over the poppet 160 and body 161 of the poppet 160 may translate through the poppet opening 143 of the cover 140 and the poppet opening 133 of the base 110. The poppet 160 may include a cover seal 169 between the cover 140 and the poppet 160 to retain air passing between the cover 140 and the poppet 160. The cover seal 169 may be lubricated to allow the poppet 160 to freely translate relative to the cover 140.

The set ring 180 is disposed within the adjustment portion 122 of the base 110 and about the body 161 of the poppet 160. The body 161 of the poppet 160 is free to translate through the set ring 180 in the inward and outward directions. The set ring 180 has an outer circumferential wall that is threaded and configured to cooperate with the threads on the inside surface of the adjustment portion 122 to position the set ring 180 within the base 110. The position of the set ring 180 within the base adjusts the biasing force of the biasing member 190 on the poppet 160 and thus, a pressure of air that the poppet 160 is set to retain within the air channel 111 and thus, within a tire cavity defined between a tire and the wheel 10.

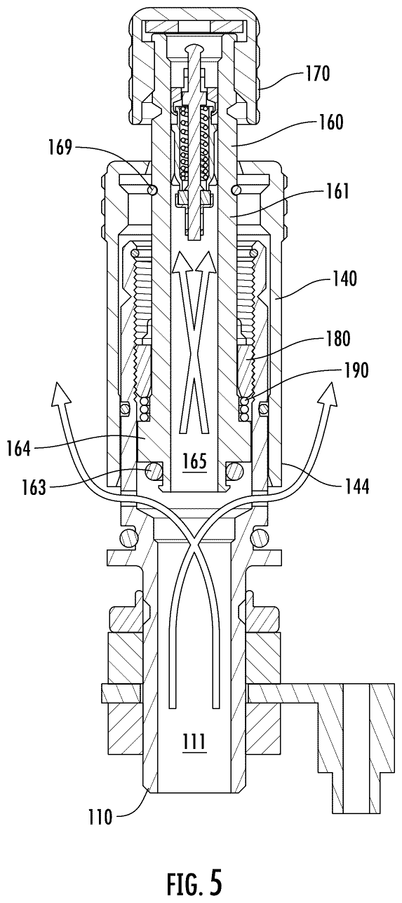

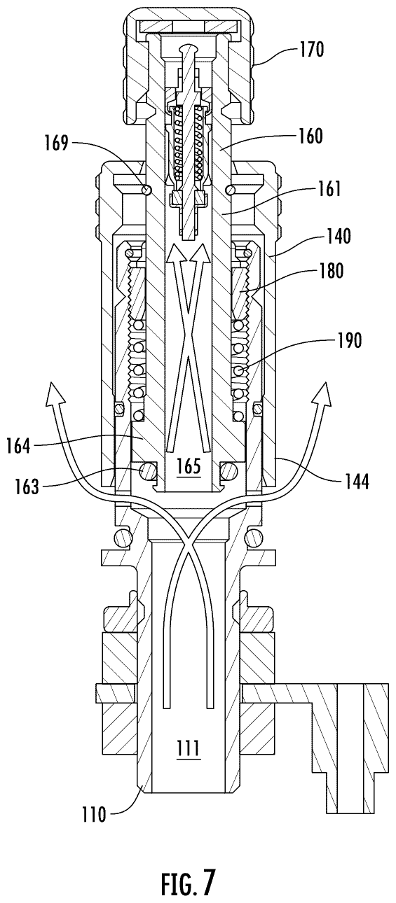

The biasing member 190 is disposed about the body 161 of the poppet 160 between the stop 164 and the set ring 180. The biasing member 190 may be a coil spring, a compression spring, or other biasing member that is configured to expand when compressed to exert force to lengthen the biasing member 190. The closing force exerted by the biasing member 190 may vary based on the length of the biasing member 190. For example, when the biasing member 190 is long as in a minimum pressure configuration (FIG. 7), the closing force exerted by the biasing member 190 on the poppet 160 is lower than the closing force exerted by the biasing member 190 on the poppet 160 when in the maximum pressure configuration (FIG. 5) when the length of the biasing member 190 is shorter. As detailed below, adjusting the position of the set ring 180 within the adjustment portion 122 adjusts the closing force exerted by the biasing member 190 on the poppet 160 and thus, an air pressure retained within the tire cavity by the poppet 160. The length of the biasing member 190 may be measured along a longitudinal axis of the tire deflator 100 which is parallel to the inward and outward directions.

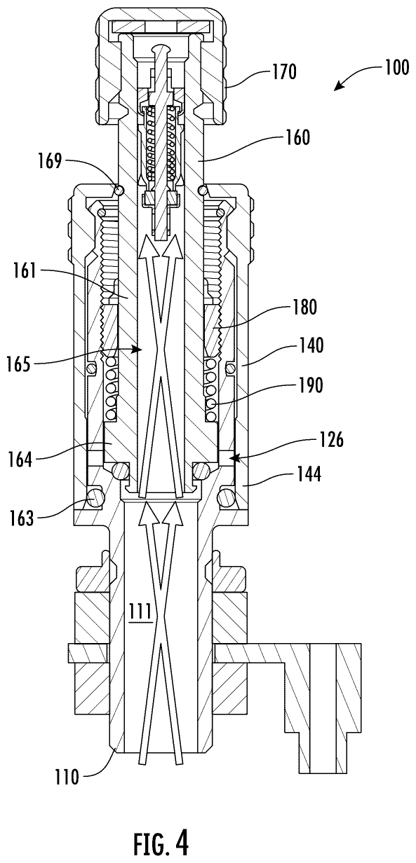

Referring now to FIGS. 4-9, the configurations of the tire deflator 100 are described in accordance with the present disclosure. Specifically, the tire deflator 100 includes a closed configuration, a max pressure configuration (show in open and closed poses), a minimum pressure configuration, an adjusting configuration, and an air up configuration.

With particular reference to FIG. 4, in the closed configuration, the tire deflator 100 is configured to maintain a pressure within the air channel 111 and thus, a tire cavity between a tire and a wheel. In the closed configuration, the cover 140 is secured to the base 110 and the cap 170 is secured to the poppet 160. In the closed configuration, the shell 144 of the cover 140 occludes and seals the deflation ports 126 of the base 110 and the cap 170 seals an outward end of the poppet 160. The cover 140 may engage the cover seal 169 to draw the poppet 160 towards a closed pose in which the poppet seal 163 seals the deflation ports 126.

Referring now to FIGS. 5 and 6, the tire deflator 100 is in the maximum pressure configuration and shown in an open pose (FIG. 5) and a closed pose (FIG. 6). In the maximum pressure configuration, the cover 140 is unsecured from the base 110 and the cap 170 is secured to the poppet 160. With the cover 140 unsecured to the base 110, the shell 144 of the cover 140 is positioned outward of the deflation ports 126. In addition, with the cover 140 unsecured, only the poppet 160 retains air within the air channel 111 of the base 110 when the air pressure is below a desired pressure. Specifically, the air within the air channel 111 flows into the poppet air channel 165 to urge the poppet 160 against the urging of the biasing member 190. When the air pressure within the air channel 111 is greater than the desired pressure, the poppet 160 is in an open pose such that the deflation ports 126 allow air to escape from within the air channel 111 until the air pressure is at the desired pressure. As shown in FIG. 6, when the air pressure in the air channel 111, and thus the poppet air channel 165, is at or below the desired pressure the biasing member 190 urges the poppet 160 inward until the poppet 160 is in the closed pose. In the closed pose, the poppet seal 163 engages the base 110 such that the deflation ports 126 are closed and the poppet 160 retains air within the air channel 111. When the air pressure is at the desired pressure, the cover 140 is secured to the base 110 such that the tire deflator 100 is in the closed configuration as shown in FIG. 4.

With reference to FIGS. 5 and 7, the difference between the maximum pressure configuration and the minimum pressure configuration is shown by the position of the set ring 180. Specifically, in the maximum pressure configuration, the set ring 180 is positioned within the adjustment portion 122 of the base 110 such that the set ring 180 is closer to the retaining flange 120 than in the minimum pressure configuration. It will be appreciated that the closer to the retaining flange 120 that the set ring 180 is positioned, the length of the biasing member 190 is decreased such that a force of the biasing member 190 on the stop 164 of the poppet 160 is greater such that a higher air pressure is required to translate the poppet 160 against a force of the biasing member 190 to open the deflation ports 126. As shown, in the minimum pressure configuration, the set ring 180 is positioned outward from the maximum pressure configuration such that the biasing member 190 has a greater length such that less pressure is required to translate the poppet outward against the force of the biasing member 190.

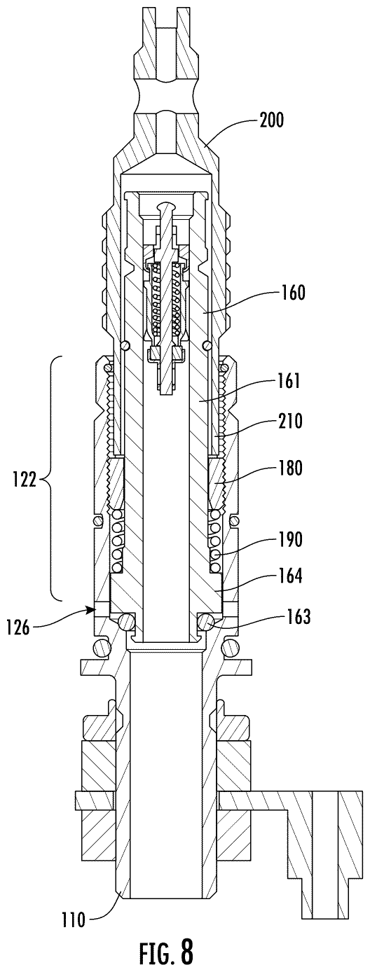

With particular reference to FIG. 8, the position of the set ring 180 can be adjusted with an adjustment tool 200. To adjust the position of the set ring 180, the cover 140 and the cap 170 are removed and the adjustment tool 200 is positioned over the poppet 160. The adjustment tool 200 includes fingers 210 that engage the set ring 180 to rotate the set ring 180 within the base 110. As the set ring 180 is rotated, the threads on the outer circumferential wall of the set ring 180 cooperate with the threads on the interior surface of the adjustment portion 122, the position of the set ring 180 within the base 110 is adjusted to move the set ring 180 between a maximum pressure configuration and a minimum pressure configuration. In embodiments, the maximum pressure may be in a range of 26 psi to 60 psi; e.g., 26, 27, 28, 29, 30, 31, 32, 33, 34, 35, 36, 37, 38, 39, 40, 41, 42, 43, 44, 45, 46, 47, 48, 49, 50, 51, 52, 53, 54, 55, 56, 57, 58, 59, or 60 psi; and the minimum pressure may be in a range of 1 psi to 14 psi; e.g., 1, 2, 3, 4, 5, 6, 7, 8, 9, 10, 11, 12, 13, or 14 psi. The set ring 180 may maintain its position such that the set desired pressure may be any pressure between the minimum pressure and the maximum pressure. In certain embodiments, the maximum pressure may be greater than 60 psi. When the set ring 180 is at a position that is configured to maintain a desired pressure within the air channel 111, the adjustment tool 200 is removed and the cover 140 and the cap 170 are secured to the base 110 and the poppet 160, respectively. In some embodiments, each rotation of the set ring 180 by adjustment tool 200 adjusts the set pressure in a range between 1 and 4 psi, e.g., between 2 and 3 psi. The set pressure of the set ring 180 may be measured via the valve 176 of the tire deflator 100 or via a second valve on the same wheel.

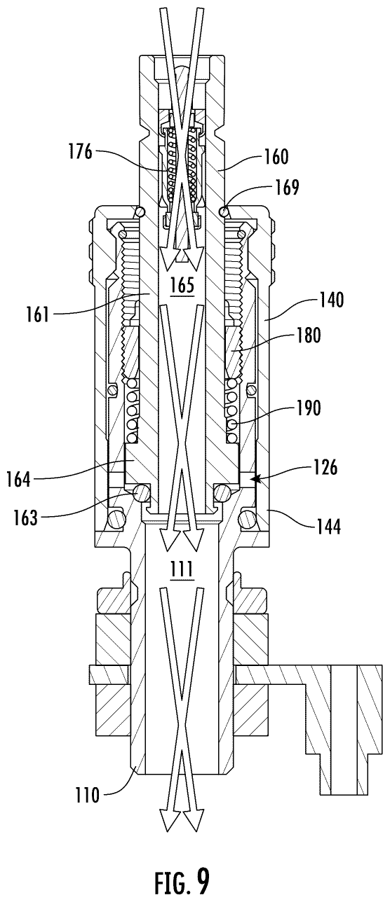

Referring to FIG. 9, the tire deflator 100 has an air up configuration in which a tire may be inflated to a pressure greater than the maximum pressure. Specifically, the air up configuration may be used to refill a tire after it is aired out. A user may want to refill a tire after driving over rough terrain and moving to a paved or smooth terrain. In the air up configuration, the cap 170 is removed and the Shrader valve 176 is used in a traditional manner to refill the tire. In the air up configuration, the cover 140 is secured to the base 110 with the shell 144 occluding and sealing the deflation ports 126. In the air up configuration, the cover 140 may draw the poppet 160 to the closed pose in which the poppet 160 closes the deflation ports 126. When the tire is refilled, the cap 170 is replaced to return the tire deflator 100 to the closed configuration.

The tire deflator 100 described herein may be used with a single valve tire to provide a single set pressure, e.g., an air out pressure. The air out pressure may be any desired pressure between the minimum and maximum pressure of the tire deflator 100. The air out pressure may be set for off-road terrain. In certain embodiments, the air out pressure may be set for an unloaded trailer or truck. In some embodiments, the tire deflator 100 may be used in a two-valve tire with a first tire deflator 100 used to set an air out pressure and the second tire deflator 100 used to set an air up pressure. In such a configuration, a tire could be aired out to a low pressure setting for rough terrain or unloaded use with the first tire deflator 100 and the second tire deflator 100 could be used to set an air up pressure for smooth terrain or loaded use. In such a configuration, when a tire is being aired up, the first tire deflator 100 would be used with the second tire deflator with the cover 140 off to allow the poppet 160 to move towards the open pose when the tire reaches the air up pressure. Such a configuration may allow for gaugeless airing up.

While several embodiments of the disclosure have been shown in the drawings, it is not intended that the disclosure be limited thereto, as it is intended that the disclosure be as broad in scope as the art will allow and that the specification be read likewise. Any combination of the above embodiments is also envisioned and is within the scope of the appended claims. Therefore, the above description should not be construed as limiting, but merely as exemplifications of particular embodiments. Those skilled in the art will envision other modifications within the scope of the claims appended hereto.

What is claimed:

1. A tire deflator comprising:
a base configured to secure in a valve port of a wheel, the base defining an air channel configured to be in fluid communication with a tire cavity, the base defining a deflation port in selective fluid communication with the air channel;
a cover having a secured position in which the cover occludes the deflation port and an unsecured position in which the cover is positioned outward of the deflation port;
a poppet having a body configured to translate inward and outward within the base between an open pose in which the poppet is positioned to allow air to flow from the air channel through the deflation port and a closed pose in which the poppet is positioned to occlude the deflation port, the poppet free to translate between the open pose and the closed pose when the cover is in the unsecured position; and
a biasing member positioned within the base, the biasing member exerting a closing force on the poppet to urge the poppet towards the closed pose, the poppet configured to release air from the air channel until air pressure within the air channel is at a set air pressure when the cover is in the unsecured position and the air pressure within the air channel is above the set air pressure.

2. The tire deflator according to claim 1, further comprising a set ring disposed within the base and about the body of the poppet, the biasing member disposed between the set ring and a stop on an inward end portion of the poppet.

3. The tire deflator according to claim 2, wherein the set ring is translatable within the base along the body of the poppet such that a closing force of the biasing member on the poppet is adjusted between a maximum closing force associated with a maximum set air pressure and a minimum closing force associated with a minimum set air pressure.

4. The tire deflator according to claim 3, wherein the maximum set air pressure is in a range of 24 psi to 36 psi and the minimum set air pressure is in a range of 4 psi to 12 psi.

5. The tire deflator according to claim 2, wherein the set ring is translatable relative to the base to adjust the set air pressure.

6. The tire deflator according to claim 5, wherein the set ring is rotated relative to the base to translate the set ring relative to the base.

7. The tire deflator according to claim 1, further comprising a tire pressure monitoring system mount configured to be disposed within a tire cavity defined between a wheel and a tire.

8. The tire deflator according to claim 1, wherein the base is configured to pass through and mount within a standard valve port in a wheel.

9. The tire deflator according to claim 1, wherein in the secured position of the cover, the cover is threadably coupled to the base and the cover retains the poppet in the closed pose thereof.

10. The tire deflator according to claim 2, further comprising a snap ring disposed adjacent an outward end of the base, the snap ring retaining the set ring within the body.

11. A wheel system comprising:
a wheel defining a valve port configured to be in fluid communication with a tire cavity defined between the wheel and a tire mounted to the wheel; and
a tire deflator according to claim 1.

12. The wheel system according to claim 11, further comprising a tire mounted to the wheel to define the tire cavity between the wheel and the tire.

13. A tire deflator comprising:
a base configured to secure in a valve port of a wheel, the base defining an air channel configured to be in fluid communication with a tire cavity, the base defining a deflation port in selective fluid communication with the air channel;
a poppet having a body configured to translate inward and outward within the base between an open pose in which the poppet is positioned to allow air to flow from the air channel out the deflation port and a closed pose in which the poppet is positioned to occlude the deflation port to retain air within the air channel; and
a biasing member positioned within the base, the biasing member exerting a closing force on the poppet to urge the poppet towards the closed pose, the poppet configured to be urged towards the open pose by air pressure within the air channel, the poppet configured to self-seal the deflation port when the closing force is greater than a force exerted on the poppet by the air pressure within the air channel such that a set air pressure is retained in the air channel.

14. The tire deflator according to claim 13, further comprising a set ring disposed within the base and about the body of poppet, the biasing member disposed between the set ring and a stop of the poppet disposed in an inward end portion of the poppet.

15. The tire deflator according to claim 14, wherein the set ring is translatable relative to the base to adjust the closing force of the biasing member and the set air pressure.

16. A method of airing down a tire, the method comprising:
releasing a poppet of a tire deflator installed in a valve port of a wheel such that air pressure within a tire cavity defined between the wheel and the tire urge the poppet outward towards an open pose of the poppet to expose a deflation port of a base of the tire deflator, the base secured within the valve port of the wheel; and
waiting for the poppet to self-seal the deflation port when the pressure within the tire cavity is at a set air pressure.

17. The method according to claim 16, wherein releasing the poppet includes rotating a cover secured to the base to release the cover and the poppet, the cover occluding the deflation port and retaining the poppet in a closed pose when secured to the base.

18. The method according to claim 16, wherein waiting for the poppet to self-seal the deflation port includes a biasing member exerting a closing force on the poppet to urge the poppet towards a closed pose in which the poppet seals the deflation port.

19. The method according to claim 18, further comprising adjusting the closing force of the biasing member by rotating a set ring threadably coupled to the base about a body of the poppet to adjust the set air pressure.

20. The method according to claim 16, further comprising:
rotating a cover to secure the cover to the base and to occlude the deflation port; and
adding air into an outward end of the poppet through a valve installed within the poppet such that the pressure within the tire cavity is greater than the set air pressure.
